(19) United States
(12) Patent Application Publication
(10) Pub. No.: US 2007/0021947 A1
(43) Pub. Date: Jan. 25, 2007

(54) MODEL TUNING SYSTEM

(75) Inventor: Karel Marik, Revnice (CZ)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/161,086

(22) Filed: Jul. 22, 2005

(51) Int. Cl. G06F 17/10

(52) U.S. Cl. 703/2

(57) ABSTRACT

A system or algorithm for model tuning and adaptation. The algorithm may be used for system identification and modeling. There may be an estimation of model structure and parameters. There may be filtering for estimating model structure and tuning model parameters. There may additionally be model adaptation in a case of modeling a time-variant system. Each particle of the filter may represent a model structure and model parameters of a system. The weight of a particle may be proportional to an underlying model's ability to simulate a system. The algorithm may continue evaluation by resampling the particle set, applying dynamics to each particle of the set, and updating the particle weight.

### BACKGROUND

The present invention pertains to system identification and particularly pertains to system modeling. More particularly, the invention pertains to an estimation of model structure and to tuning of model parameters.

### SUMMARY

The invention is a system for model tuning and automatic model adaptation.

### BRIEF DESCRIPTION OF THE DRAWINGS

FIG. 1 is shows a model filter algorithm outline; and

FIG. 2 is a schematic of a model filter algorithm layout.

### DESCRIPTION

The problem addressed by the present invention is system identification and system modeling, and more specifically may be an estimation of model structure and model parameters. The invention may involve model selection, feature selection, parameter tuning, and the like. Particle filtering may be an instrument (i.e., a tool or means) of the invention. Model selection, feature selection, parameter tuning and/or model adaptation may be a goal or objective of the invention.

Invention may be a system inspired by an object tracking algorithm used in digital video surveillance applications called particle filtering (aka condensation). The system may use particle filtering for (i) estimating model structure, for (ii) tuning model parameters, and for (iii) on-line model adaptation in the case of modeling a time-variant system. A weighted particle set may be an approximate representation of a probability distribution. Each particle of a particle filter may represent a model (both model structure and model parameters) of a system. Particle weight may be proportional to underlying model's ability to simulate a system. An algorithm utilized may include repeating an evaluation of the following steps. First, there may be a resampling of a particle set in order to accept successful models and to reject unsuccessful ones. The particles may be accepted with probabilities proportional to their weights. Second, dynamics may be applied to each particle (model)—model structure is altered and model parameters are randomly updated. Third, the particle weight may be updated in order to represent ability of model to simulate system.

Such an algorithm may be suitable to determine model structure, model parameters and even be able to update a model of a time-variant system. The present system may be implemented as a model selection tool for a local regression forecaster. The algorithm may perform both feature (variable) selection from given set of available features and parameter tuning. But generally, it is applicable for different classes of models, also (e.g., time series arima models, neural nets, and so forth).

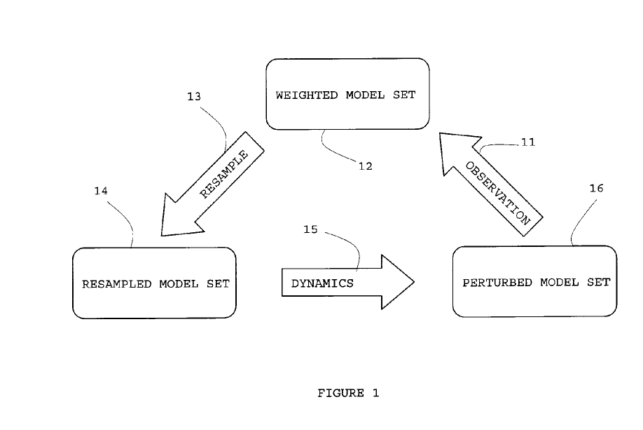

Particle filtering may be utilized for model tuning and adaptation. FIG. 1 shows an outline of a model filter algorithm. Each particle of a particle filter may represent a model (i.e., both a model structure and model parameters of a system). At an observation 11, weights may be assigned to each model. Weights may be proportional to an ability of a model to simulate the system. The result of an observation may be a weighted model set 12. In a resample 13, models may be cloned with a probability proportional to their weights. Good models may be duplicated and bad models rejected. The resample 13 may result in a resampled model set 14. In dynamics 15 for all models, model parameters and even a model structure may randomly perturbed. The dynamics 15 may result in a perturbed model set 16. Observation 11 may occur again and the cycle or process may be repeated.

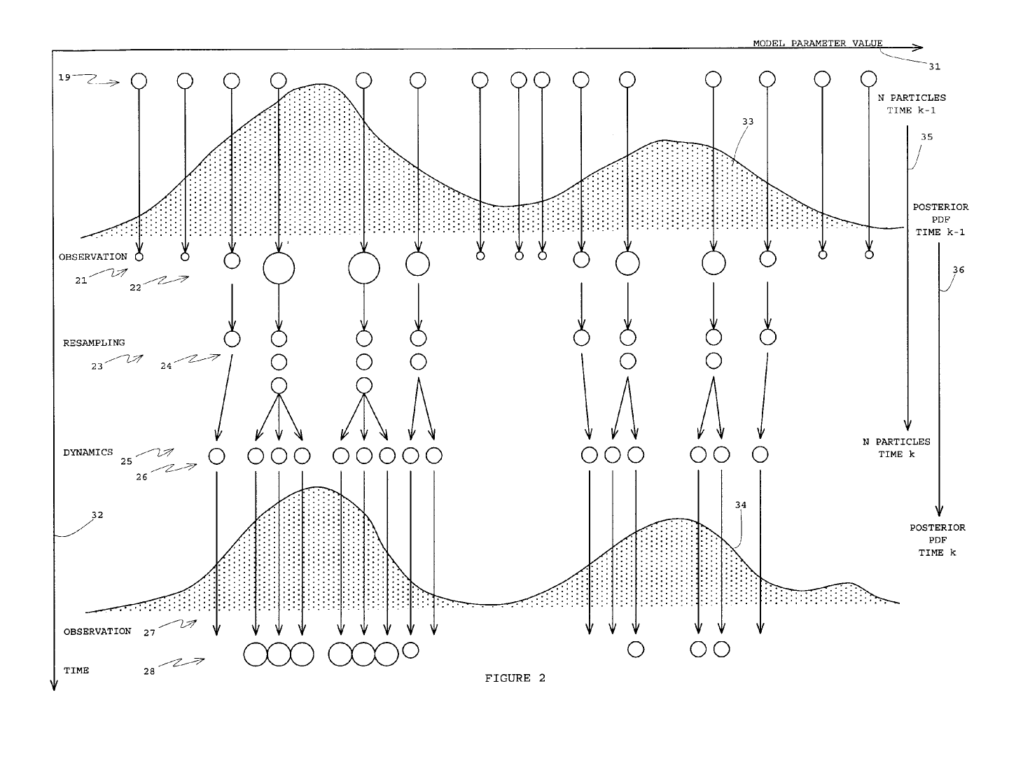

FIG. 2 is a schematic view of one time step of model adaptation algorithm. One may begin with a model set 19. There may be an observation 21 which may involve model verification. Subsequent to the observation 21, there may be a resampling 23 of the weighted model set 22 in a resampled model set 24. A dynamics 25 approach involving a parameters/structure random update of the resampled set 24, may result in a perturbed model set 26. An observation 27 may be used for model verification for a resulting model set 28.

An abscissa 31 of the schematic may represent a model parameter value and the ordinate 32 may represent time. Curve 33 may represent probability density function the model parameter value at time k-1 which is approximated by weighted particle set 22. Curve 34 may represent changed probability density function the model parameter value at time k which is approximated by updated weighted particle set 28. Line 35 shows time update of N particles of set 19 at time k-1 to N particles of set 26 at time k. Line 36 shows changing of time variant model parameter's probability density function (pdf) at time k-1 approximated by weighted particle set 22 to a model parameter's posterior pdf at time k approximated by particle set 28.

Use cases may involve model parameters tuning, model structure estimation and on-line model adaptation. Relative to the model parameters tuning, if a model structure is fixed, then an algorithm cycle-by-cycle may tune the model parameters (i.e., order of polynomial fit, smoothing coefficient, or the like).

As to model structure estimation, if reversible model structure changes are allowed, then an algorithm may perform both structure estimation and model tuning (e.g., model variable selection). Candidate models may be from rather different families (e.g., regression models, time series models, neural networks, or the like). In fact, the changing of a model structure may involve a changing of the number of tuned parameters and thus a changing of the problem dimension.

Relative to on-line model adaptation, if system history data are regularly updated and the observation (or the model verification process) reflects the most recent system behavior, then the algorithms may adapt models (parameters and structure) in order to reflect system behavior changes. One algorithm cycle may correspond to one time step of measured system behavior in the present case.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A method for particle filtering, comprising:
providing a model set;
assigning weights to each model to result in a weighted model set;
resampling the weighted model set to result in a resampled model set; and
applying dynamics to the resampled model set to result in a perturbed model set.

2. The method of claim 1, wherein the weights are proportioned to an ability of a model to simulate a system.

3. The method of claim 2, wherein the resampled model set comprises models cloned with a probability proportional to their weights.

4. The method of claim 3, wherein good models are duplicated and the bad models are rejected in the resampling.

5. The method of claim 4, wherein parameters and structures of the models are randomly perturbed in the applying dynamics to the model set.

6. The method of claim 5, wherein each particle of the particle filter represents a model of a system.

7. The method of claim 6, wherein a model comprises a structure and parameters.

8. The method of claim 7, wherein the particle filter is used for model tuning and adaption.

9. A system of model tuning and adaption, comprising:
a model verification mechanism;
a resampling mechanism associated with an input to the model verification mechanism; and
a dynamics mechanism associated with an input to the resampling mechanism.

10. The system of claim 9, wherein the dynamics mechanism is associated with an input to the model verification mechanism.

11. The system of claim 10, wherein the model verification mechanism, the resampling mechanism and dynamics mechanism operate in a repetitive sequence.

12. The system of claim 10, wherein the dynamics mechanism provides an update of parameters and structure of a model.

13. The system of claim 10, wherein the dynamic mechanism provides a perturbation of the parameters of the model.

14. The system of claim 12, wherein:
the structure is fixed; and
the parameters are tuned.

15. The system of claim 12, wherein:
the structure has reversible changes;
the structure is estimated; and
the parameters are tuned.

16. The system of claim 12, wherein a change of structure changes the number of tuned parameters.

17. The system of claim 12, wherein an algorithm adapts parameters and structure of the models to reflect system behavior changes.

18. A model tuning algorithm comprising:
estimating a structure of a model;
tuning parameters of the model; and
adapting the model on-line for modeling a time-variant system.

19. The algorithm of claim 18, wherein:
each model is represented by a particle; and
each particle has a weight proportional to an ability of a model to simulate a system.

20. The algorithm of claim 19, wherein an algorithm evaluation comprises:
resampling a particle set to keep successful models and to reject unsuccessful models;
applying dynamics to each particle; and
updating the weight of the particle.

21. The algorithm of claim 20, wherein applying dynamics comprises:
altering a structure of a model; and
updating the parameters of the model.

22. The algorithm of claim 21, wherein the weight of the particle is updated.

23. The algorithm of claim 20, wherein particles are selected with probabilities proportional to their weights.
